(19) United States
(12) Patent Application Publication
(10) Pub. No.: US 2017/0068527 A1
(43) Pub. Date: Mar. 9, 2017

(54) DEVICE CONTROL METHOD AND APPARATUS

(71) Applicant: XIAOMI INC., BEIJING (CN)

(72) Inventors: YUANBO WANG, BEIJING (CN); HAO CHEN, BEIJING (CN); ENXING HOU, BEIJING (CN)

(73) Assignee: XIAOMI INC., BEIJING (CN)

(21) Appl. No.: 15/203,501

(22) Filed: Jul. 6, 2016

(30) Foreign Application Priority Data
Sep. 9, 2015 (CN) 201510570590.6

(51) Int. Cl. G06F 9/445

(52) U.S. Cl. CPC G06F 8/61

(57) ABSTRACT

The disclosure relates to a method and an apparatus for controlling a device. The method includes receiving a control instruction associated with a first device; determining that a first program plugin is not installed, wherein the first program plugin is configured to control the first device; acquiring the first program plugin from a server, the first program plugin including a control interface and a control logic; determining that a second program plugin is installed, wherein the second program plugin is configured to control a first set of devices that are different from the first device; installing the first program plugin based on the determination that the second program plugin is installed; and controlling the first device based on the control instruction and the first program plugin.

### CROSS-REFERENCE TO RELATED APPLICATIONS

This application is based on and claims priority to Chinese Patent Application No. 201510570590.6, filed on Sep. 9, 2015, the entire contents of which are incorporated herein by reference.

### TECHNICAL FIELD

The present disclosure relates to the field of communications technologies, and more particularly, to a device control method and apparatus.

### BACKGROUND

With the rapid development of mobile terminal technologies, various mobile terminals such as mobile phones are widely used, and functions thereof are increasingly powerful. For example, a user may install multiple applications (APP) on a mobile phone to meet different demands.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method for controlling a device. The method includes receiving a control instruction associated with a first device; determining that a first program plugin is not installed, wherein the first program plugin is configured to control the first device; acquiring the first program plugin from a server, the first program plugin including a control interface and a control logic; determining that a second program plugin is installed, wherein the second program plugin is configured to control a first set of devices that are different from the first device; installing the first program plugin based on the determination that the second program plugin is installed; and controlling the first device based on the control instruction and the first program plugin.

When installing the first program plugin, the method includes overwriting the second program plugin with the first program plugin. The first set of devices includes smart devices located within a same local area network (LAN).

When acquiring the first program plugin, the method also includes sending to the server a first request to acquire the first program plugin, wherein the first request includes an identifier of the first device, a model number of a first mobile terminal, and a version number of a first application; and receiving from the server the first program plugin based on the first request.

Before sending the first request, the method includes sending to the server a second request to acquire a list of controllable devices; receiving from the server the list of controllable devices including the identifier of the first device; and displaying the list of controllable devices, wherein the identifier of the first device is sent to the server by the first device after the first device establishes a connection with the first application.

The method also includes determining that an updated version of the first program plugin exists on the server; acquiring the updated version of the first program plugin from the server; and installing the updated version of the first program plugin.

When determining that the updated version of the first program plugin exists on the server, the method includes receiving from the server a push notification indicating that the updated version of the first program plugin exists on the server.

When determining that the updated version of the first program plugin exists on the server, the method includes sending to the server a program plugin version search request including an identifier of the first device; receiving from the server a latest version number of the first program plugin corresponding to the first device; and determining that the updated version of the first program plugin exists on the server when the latest version number is greater than a current version number of the first program plugin.

The first program plugin and the updated version of the first program plugin are stored in a first mobile terminal. The updated version of the first program plugin includes (i) an identifier and a version number of the first device, or (ii) identifiers and version numbers of the first device and other devices to be controlled.

Aspects of the disclosure also provide an apparatus for controlling a device. The apparatus includes a processor and a memory configured to store instructions executable by the processor. The processor is configured to receive a control instruction associated with a first device; acquire the first program plugin from a server, the first program plugin including a control interface and a control logic; determine that a second program plugin is installed, wherein the second program plugin is configured to control a first set of devices that are different from the first device; install the first program plugin based on the determination that the second program plugin is installed; and control the first device based on the control instruction and the first program plugin.

The processor is further configured to install the first program plugin by overwriting the second program plugin with the first program plugin. The first set of devices includes smart devices located within a same local area network (LAN).

When acquiring the first program plugin, the processor is configured to send to the server a first request to acquire the first program plugin, wherein the first request includes an identifier of the first device, a model number of a first mobile terminal, and a version number of a first application; and receive from the server the first program plugin based on the first request.

Before sending the first request, the processor is further configured to send to the server a second request to acquire a list of controllable devices; receive from the server the list of controllable devices including the identifier of the first device; and display the list of controllable devices, wherein the identifier of the first device is sent to the server by the first device after the first device establishes a connection with the first application.

The processor is further configured to determine that an updated version of the first program plugin exists on the server; acquire the updated version of the first program plugin from the server; and install the updated version of the first program plugin.

When determining that the updated version of the first program plugin exists on the server, the processor is configured to receive from the server a push notification indicating that the updated version of the first program plugin exists on the server.

When determining that the updated version of the first program plugin exists on the server, the processor is configured to send to the server a program plugin version search request including an identifier of the first device; receive from the server a latest version number of the first program plugin corresponding to the first current device; and determine that the updated version of the first program plugin exists on the server when the latest version number is greater than a current version number of the first program plugin.

The first program plugin and the updated version of the first program plugin are stored in a first mobile terminal. The updated version of the first program plugin includes (i) an identifier and a version number of the first device, or (ii) identifiers and version numbers of the first device and other devices to be controlled.

Aspects of the disclosure also provide a non-transitory computer-readable storage medium having stored therein instructions that, when executed by a processor, cause the processor to perform a method. The method includes receiving a control instruction associated with a first device; determining that a first program plugin is not installed, wherein the first program plugin is configured to control the first device; acquiring the first program plugin from a server, the first program plugin including a control interface and a control logic; determining that a second program plugin is installed, wherein the second program plugin is configured to control a first set of devices that are different from the first device; installing the first program plugin based on the determination that the second program plugin is installed; and controlling the first device based on the control instruction and the first program plugin.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate aspects consistent with the disclosure and, together with the description, serve to explain the principles of the disclosure.

FIG. 1 is a flowchart illustrating a device control method according to an exemplary aspect of the present disclosure;

FIG. 2 is a flowchart illustrating another device control method according to an exemplary aspect of the present disclosure;

FIG. 3 is a flowchart illustrating another device control method according to an exemplary aspect of the present disclosure;

FIG. 4 is a schematic diagram illustrating an interface for downloading a target plug-in according to an exemplary aspect of the present disclosure;

FIG. 5 is a flowchart illustrating another device control method according to an exemplary aspect of the present disclosure;

FIG. 6 is a flowchart illustrating another device control method according to an exemplary aspect of the present disclosure;

FIG. 7 is a schematic diagram illustrating a plug-in selecting interface according to an exemplary aspect of the present disclosure;

FIG. 8 is a block diagram illustrating a device control apparatus according to an exemplary aspect of the present disclosure;

FIG. 9A is a block diagram illustrating another device control apparatus according to an exemplary aspect of the present disclosure;

FIG. 9B is a block diagram illustrating another device control apparatus according to an exemplary aspect of the present disclosure;

FIG. 9C is a block diagram illustrating another device control apparatus according to an exemplary aspect of the present disclosure;

FIG. 9D is a block diagram illustrating another device control apparatus according to an exemplary aspect of the present disclosure;

FIG. 9E is a block diagram illustrating another device control apparatus according to an exemplary aspect of the present disclosure;

FIG. 9F is a block diagram illustrating another device control apparatus according to an exemplary aspect of the present disclosure;

FIG. 10 is a block diagram illustrating a further device control apparatus according to an exemplary aspect of the present disclosure;

FIG. 11 is a block diagram illustrating a still further device control apparatus according to an exemplary aspect of the present disclosure; and

FIG. 12 is a block diagram applicable to a device control apparatus according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Reference will now be made in detail to exemplary aspects, examples of which are illustrated in the accompanying drawings. The following description refers to the accompanying drawings in which the same numbers in different drawings represent the same or similar elements unless otherwise represented. The implementations set forth in the following description of exemplary aspects do not represent all implementations consistent with the disclosure. Instead, they are merely examples of apparatuses and methods consistent with aspects related to the disclosure as recited in the appended claims.

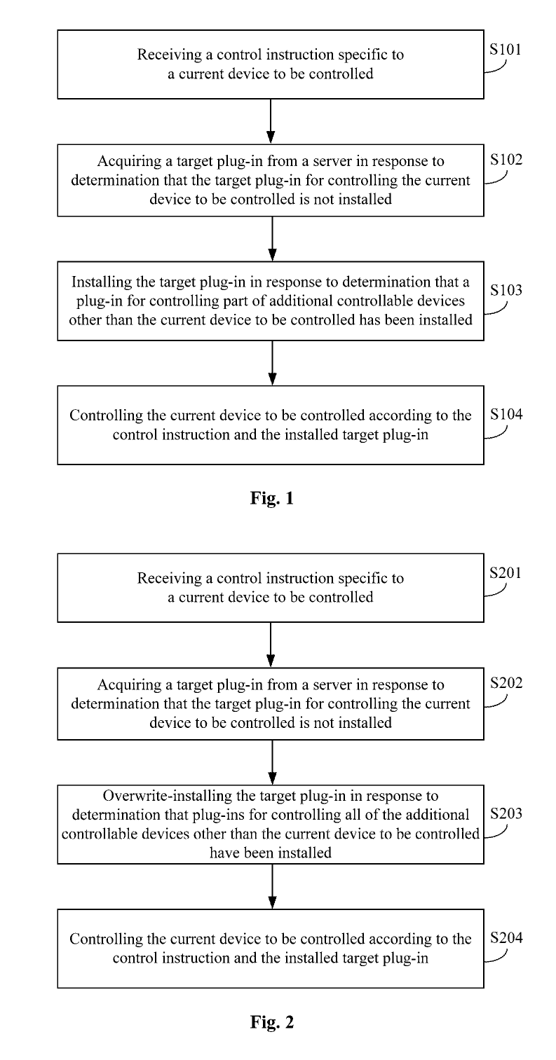

FIG. 1 is a flowchart illustrating a device control method according to an exemplary aspect. As shown in FIG. 1, the device control method may be applied to a mobile terminal provided with a preset APP, the mobile terminal may include a mobile phone, a tablet computer (PAD) or the like, and the method includes the following steps.

In Step S101, a control instruction specific to a current device to be controlled is received.

In this aspect, when a user expects to control a certain smart device via a preset APP (such as Xiaomi™ Smarthome APP) on a mobile terminal (such as a mobile phone), the user may click the smart device, and the preset APP may receive the control instruction specific to the current device to be controlled.

In Step S102, a target plug-in (e.g., a first program plugin) is acquired from a server in response to determination that the target plug-in for controlling the current device to be controlled is not installed, where the target plug-in includes a control interface and a control logic.

In this aspect, in order to reduce space occupied by the preset APP, the preset APP only has basic functions of device connecting and binding and the like, and the control interface and the control logic for the controllable device of the preset APP are packaged into a plug-in and stored in the server.

The control interface and the control logic for one controllable device may be packaged as one plug-in, and the control interfaces and the control logics for multiple controllable devices may also be packaged into one plug-in. For example, a company develops three new products, the control interfaces and the control logics for the three new products (namely, three devices) may be packaged into one plug-in.

The controllable devices of the preset APP may include smart devices located within a same LAN. For example, the controllable device may be a smart device connected by the user to the APP within a current LAN using an account number of the user.

In this aspect, after receiving the control instruction specific to the current device to be controlled, the preset APP determines whether the target plug-in for controlling the current device to be controlled is installed on the current mobile terminal such as a mobile phone, and acquires the target plug-in from the server if the target plug-in is not installed yet.

In Step S103, the target plug-in is installed in response to determination that a plug-in (e.g., second program plugin) for controlling part of additional controllable devices (e.g., a first set of devices) other than the current device to be controlled has been installed.

In this aspect, after the target plug-in is acquired, the target plug-in is installed when the plug-ins corresponding to part of the additional controllable devices other than the current device to be controlled have been installed in the APP.

In an aspect, the current device to be controlled is also a controllable device.

Supposing the controllable devices of the APP include device 1 to device 100, and the current device to be controlled is the device 1 and plug-ins for device 2 to device 50 have been installed in the APP, the target plug-in of the device 1 can be thus installed because the plug-ins of part of the additional controllable devices other than the current device to be controlled have been installed in the APP.

In Step S104, the current device to be controlled is controlled according to the control instruction and the installed target plug-in.

In this aspect, after the target plug-in for the current device to be controlled is installed, the current device to be controlled may be controlled according to the control instruction and the installed target plug-in.

In the foregoing aspects of the device control method, the target plug-in is acquired from the server when it is determined that the target plug-in for controlling the current device to be controlled is not installed, and the target plug-in is installed when it is determined that a plug-in for controlling part of additional controllable devices other than the current device to be controlled has been installed, thus the current device to be controlled may be controlled according to the installed target plug-in. The target plug-in was saved on the server previously and is not acquired from the server unless it is needed, and the target plug-in is installed when the plug-ins for part of additional controllable devices other than the current device to be controlled are installed locally, i.e., after the target plug-in is installed, merely the plug-ins for only part of additional controllable devices are installed locally. Therefore, space occupied by the APP is greatly reduced.

FIG. 2 is a flowchart illustrating another device control method according to an exemplary aspect. As shown in FIG. 2, the method includes the following steps.

Steps S201-S202 are the same as Steps S101-S102, and thus are not described herein.

In Step S203, the target plug-in is overwrite-installed in response to determination that plug-ins for controlling all of the additional controllable devices other than the current device to be controlled have been installed.

In this aspect, the plug-ins for all of the additional controllable devices other than the current device to be controlled have been installed on the APP. Accordingly, in order to save memory space, after the target plug-in is acquired, the target plug-in is overwrite-installed in the APP.

Overwrite-installation means that a plug-in for one controllable device installed previously is overwritten by the target plug-in for the current device to be controlled, namely, no plug-in is additionally installed, thereby reducing occupied space.

Supposing the controllable devices of the APP include device 1 to device 100, the current device to be controlled is the device 1 and plug-ins for device 2 to device 100 have been installed in the APP. Since the plug-ins for all of additional controllable devices other than the current device to be controlled have been installed on the APP, in order to save memory space, the target plug-in for the device 1 is overwrite-installed, for example, a plug-in for the device 2 is overwritten by the target plug-in for the device 1.

It is to be noted that, in this aspect the device 2 is taken as the overwritten device, but in practical application, the overwritten device may be selected according to different strategies. For example, the overwritten device may be randomly selected or selected in sequence and so on.

Step S204 is the same as Step S104, and thus is not described herein.

In the foregoing aspect of the device control method, the target plug-in is overwrite-installed when it is determined that plug-ins for controlling all of additional controllable devices other the current device to be controlled have been installed. In other words, a plug-in for a controllable device installed previously will be overwritten by the target plug-in for the current device to be controlled, thereby reducing space occupied by the APP.

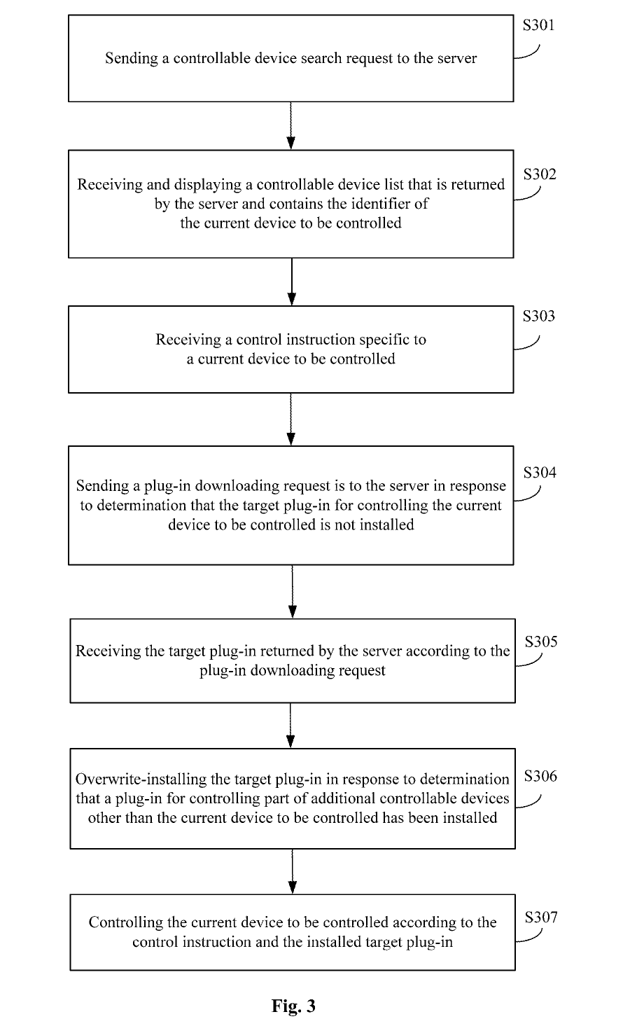

FIG. 3 is a flowchart illustrating another device control method shown according to an exemplary aspect. As shown in FIG. 3, the method includes the following steps.

In Step S301, a controllable device search request is sent to the server.

In this aspect, the user may connect a device to the APP by using the account number (such as a Xiaomi™ account number) of the user, where a binding relationship may be established between the device connected to the APP and the account number of the user. The device connected to the APP is a controllable device of the APP. An identifier of the device may be sent to the server when the device is connected to the APP so that the server can save a corresponding relation between the account number and the device identifier.

In an aspect, the device identifier includes a character string used to differentiate different types of devices.

When the user clicks a preset option such as “My Device” in the APP, the APP may send a controllable device search request to the server.

In Step S302, a controllable device list that is returned by the server and contains the identifier of the current device to be controlled is received and displayed.

After the controllable device search request is received, the server may acquire, according to identification information (such as a mobile phone number) of the current mobile terminal which is carried in the controllable device search request, an account number (such as a Xiaomi™ account number) bound with the mobile phone number, then obtains the controllable device list containing these device identifiers according to the corresponding relation among the Xiaomi™ account number, prestored account numbers and these device identifiers, and returns the controllable device list to the APP. After the APP receives the controllable device list, the controllable device list is displayed.

In Step S303, a control instruction specific to a current device to be controlled is received.

In this aspect, when the user expects to control a certain device in the controllable device list, the user may click the device, which is the current device to be controlled.

In Step S304, a plug-in downloading request is sent to the server in response to determination that the target plug-in for controlling the current device to be controlled is not installed.

The plug-in downloading request carries therein an identifier of the current device to be controlled, a model number of the current mobile terminal and a version number of the current APP.

In this aspect, the plug-in downloading request is sent to the server when the target plug-in for controlling the current device to be controlled is not installed in the current APP.

In Step S305, the target plug-in returned by the server according to the plug-in downloading request is received.

After receiving the plug-in downloading request, the server may obtain, according to the identifier of the current device to be controlled, the model number of the current mobile terminal, such as a mobile phone model number, and the version number of the current APP that are carried in the plug-in downloading request, the target plug-in for the current device to be controlled, and return the target plug-in to the APP.

An interface for acquiring the target plug-in (namely, downloading the target plug-in) in the APP is as shown in FIG. 4. In FIG. 4, the target plug-in for an air conditioner is downloaded, and from FIG. 4 it can be seen that the download progress is 36%.

In Step S306, the target plug-in is overwrite-installed in response to determination that a plug-in for controlling part of additional controllable devices other than the current device to be controlled has been installed.

After the target plug-in is acquired, the target plug-in is installed when the plug-ins for part of the additional controllable devices other than the current device to be controlled have been installed in the APP.

In order to further reduce space occupied by the APP, in this aspect, the target plug-in is overwrite-installed.

Supposing the controllable devices of the APP include device 1 to device 100, the current device to be controlled is the device 1 and plug-ins for device 2 to device 60 have been installed in the APP. Accordingly, in order to further reduce space occupied by the APP, the target plug-in for the device 1 is overwrite-installed. For example, a plug-in of device 10 may be overwritten by the target plug-in for the device 1.

In Step S307, the current device to be controlled is controlled according to the control instruction and the installed target plug-in.

In this aspect, after the target plug-in for the current device to be controlled is overwrite-installed, the current device to be controlled may be controlled according to the control instruction and the installed target plug-in.

In the foregoing aspect of the device control method, the target plug-in for the current device to be controlled is acquired by sending the plug-in downloading request to the server, which is simple to be implemented, and the target plug-in is overwrite-installed when it is determined that plug-ins for controlling part of the additional controllable devices other than the current device to be controlled have been installed, thereby further reducing space occupied by the APP.

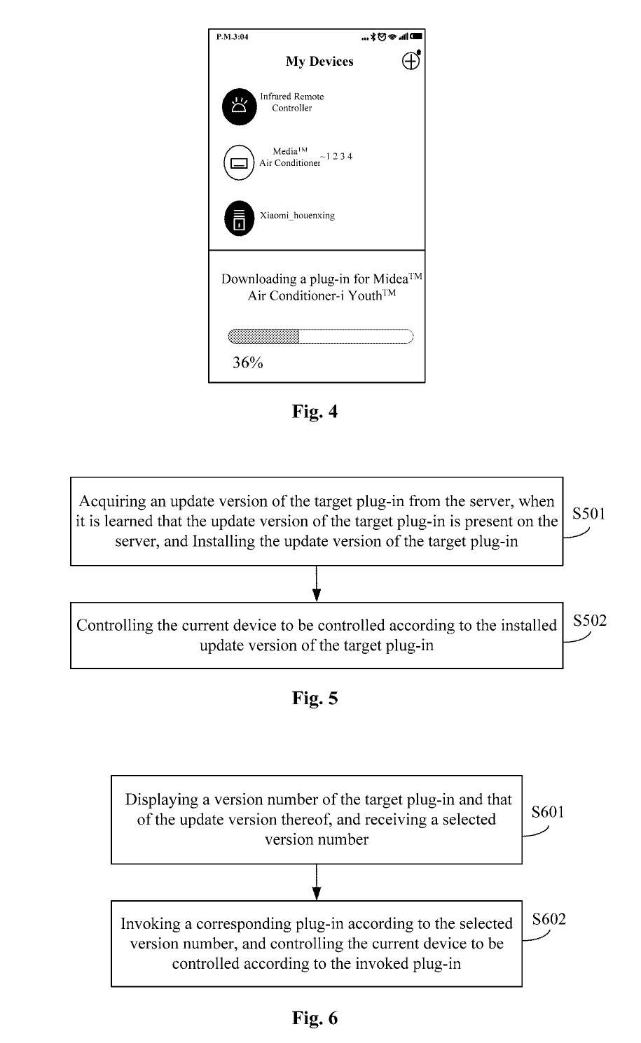

FIG. 5 is a flowchart illustrating another device control method according to an exemplary aspect. As shown in FIG. 5, after the foregoing Step S103, the method may further include the following steps.

In Step S501, when it is learned that an update version of the target plug-in is present on the server, the update version of the target plug-in is acquired from the server, and the update version of the target plug-in is installed.

It may be learned that the update version of the target plug-in is present on the server through multiple manners, for example, there following two manners.

In the first manner, a notification pushed by the server is received, where the notification is used to indicate that the update version of the target plug-in is present on the server.

In the second manner, a plug-in version search request is sent to the server, where the plug-in version search request carries therein an identifier of the current device to be controlled; a latest version number, corresponding to the current device to be controlled, returned by the server according to the plug-in version search request is then received, and it can be learned that the update version of the target plug-in is present on the server when the latest version number is greater than a current version number corresponding to the current device to be controlled.

In this aspect, after the update version of the target plug-in is acquired and installed, both the target plug-in for the current device to be controlled and the update version thereof are saved in the current mobile terminal. In other words, different versions of plug-ins for the same device are saved in the current mobile terminal such as a mobile phone.

In addition, the update version of the target plug-in may merely contain a control interface and a control logic updated for the current device to be controlled, or may contain control interfaces and control logics for other devices to be controlled or controllable devices.

For example, Company A has a new device d to be released, and a control interface and a control logic of a device b need to be updated at the same time. A developer may thus select to package the control interfaces and the control logics of both the device d and the device b into one new plug-in such as a plug-in 2. In addition, the developer may also select to separately package the control interfaces and the control logics of the device d and the device b into two new plug-ins.

Accordingly, the update version of the target plug-in for the device h is the plug-in 2, the plug-in 2 is thus acquired from the server.

In Step S502, the current device to be controlled is controlled according to the installed update version of the target plug-in.

In this aspect, after the update version of the target plug-in is installed, the current device to be controlled may be controlled according to the installed update version of the target plug-in.

In the foregoing aspect of the device control method, when it is learned that an update version of the target plug-in is present on the server, the update version of the target plug-in is acquired and installed, and the current device to be controlled is then controlled according to the installed update version of the target plug-in. This partial update manner based on plug-ins may effectively reduce network traffic resources required to be consumed.

FIG. 6 is a flowchart illustrating another device control method according to an exemplary aspect. As shown in FIG. 6, after the foregoing Step S501, the method may further include the following steps.

In Step S601, a version number of the target plug-in and that of the update version thereof are displayed, and a selected version number is received.

In this aspect, different versions of plug-ins for a same device may be simultaneously saved in the current mobile terminal. Therefore, the version numbers of both the target plug-in and the update version thereof may be displayed.

In addition, the update version of the target plug-in may merely contain a control interface and a control logic updated for the current device to be controlled, or may contain control interfaces and control logics for other devices to be controlled or other controllable devices.

For example, Company A has a new device d to be released, and a control interface and a control logic for a device b need to be updated at the same time. A developer may select to package the control interfaces and the control logics of both the device d and the device b into one new plug-in such as a plug-in 2. In addition, the developer may also select to separately package the control interfaces and the control logics for the device d and the device b into two new plug-ins.

Each plug-in contains therein an identifier of and a version number corresponding to the device. Therefore, after the version numbers of the target plug-in and the update version thereof are displayed at the APP, a version number of the plug-in can be selected according to the identifier of and the version number corresponding to the device contained in different versions of plug-ins.

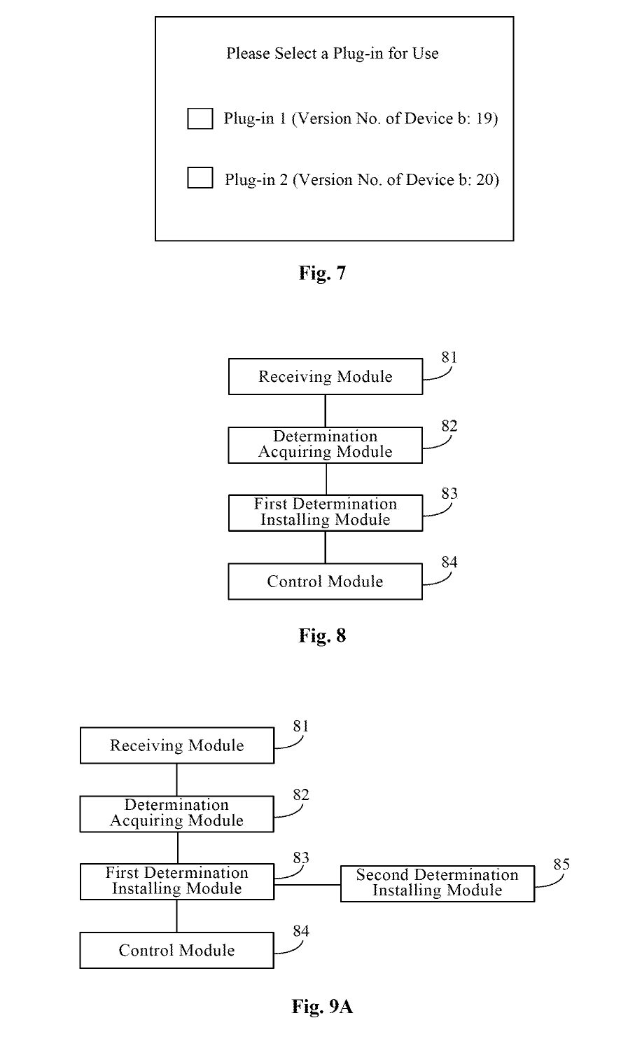

Supposing a version number corresponding to the device b in the target plug-in, for example, plug-in 1, is 19, a version number corresponding to the device b in the update version of the target plug-in (namely plug-in 2) is 20, as shown in FIG. 7. If the user feels that the version of plug-in 2 is not stable enough and thus expects to use plug-in 1, the user may select the plug-in (namely the plug-in 1) whose version number is 1.

In Step S602, a corresponding plug-in is invoked according to the selected version number, and the current device to be controlled is controlled according to the invoked plug-in.

Supposing the user selects plug-in 1, plug-in 1 may be then invoked to control the device b.

In the foregoing Steps S601-S602, the current device to be controlled is controlled via the plug-in selected by the user. In this aspect, the current device to be controlled may also be controlled through other manners. For example, a plug-in having a latest version number is used by default to control the current device to be controlled.

In an aspect, the plug-in having the latest version number can be used by default to control the current device to be controlled based on: acquiring the latest version plug-in corresponding to the current device to be controlled, and controlling the current device to be controlled according to the latest version plug-in.

For example, supposing the version number of device a in the target plug-in, for example, plug-in 3, is 19, the version number of device a in the update version of the target plug-in (namely plug-in 4) is 21, the plug-in 4 can be thus used to control device a.

In the foregoing aspect of the device control method, the selected version number is received, and a corresponding plug-in is invoked according to the selected version number to control the current device to be controlled, thereby allowing the user to select between a new version and an old version of the plug-in, and providing convenience for the user.

Corresponding to the aspects of the foregoing device control method, the present disclosure also provides aspects of the device control apparatus.

FIG. 8 is a block diagram illustrating a device control apparatus according to an exemplary aspect. As shown in FIG. 8, the device control apparatus includes: a receiving module 81, a determination acquiring module 82, a first determination installing module 83 and a control module 84.

The receiving module 81 is configured to receive a control instruction specific to a current device to be controlled.

The determination acquiring module 82 is configured to acquire a target plug-in from the server in response to determination that the target plug-in for controlling the current device to be controlled is not installed, and the target plug-in includes a control interface and a control logic.

The first determination installing module 83 is configured to install the target plug-in acquired by the determination acquiring module 82 in response to determination that a plug-in for controlling part of additional controllable devices other than the current device to be controlled has been installed.

The control module 84 is configured to control the current device to be controlled according to the control instruction received by the receiving module 81 and the target plug-in installed by the first determination installing module 83.

The controllable devices refer to smart devices located within the same LAN.

The apparatus as shown in FIG. 8 is configured to implement the method as shown in FIG. 1, with the same description of related content, and thus is not repeated herein.

In the aspect of the foregoing device control apparatus, the target plug-in is acquired from the server when the determination acquiring module determines that the target plug-in for controlling the current device to be controlled is not installed, and the target plug-in is installed when the first determination installing module determines that a plug-in for controlling part of additional controllable devices other than the current device to be controlled has been installed, thus the current device to be controlled can be controlled according to the installed target plug-in. The target plug-in was saved on the server in advance and is not acquired from the server unless it is needed, and the target plug-in is installed when a plug-in for part of additional controllable devices other than the current device to be controlled is installed locally. In other words, after the target plug-in is installed, there still are plug-ins for part of controllable devices installed locally. Therefore, space occupied by the APP is greatly reduced.

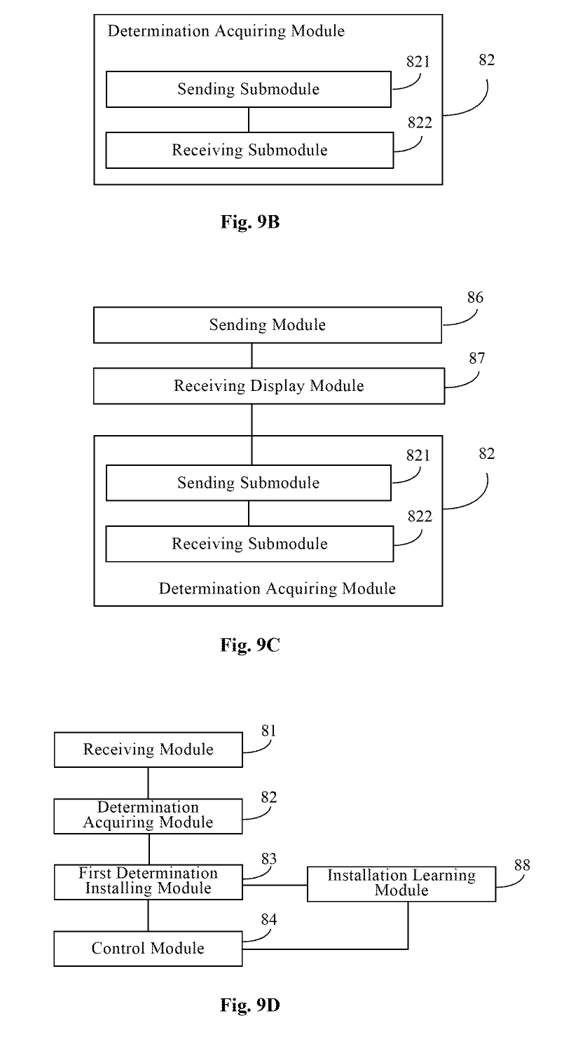

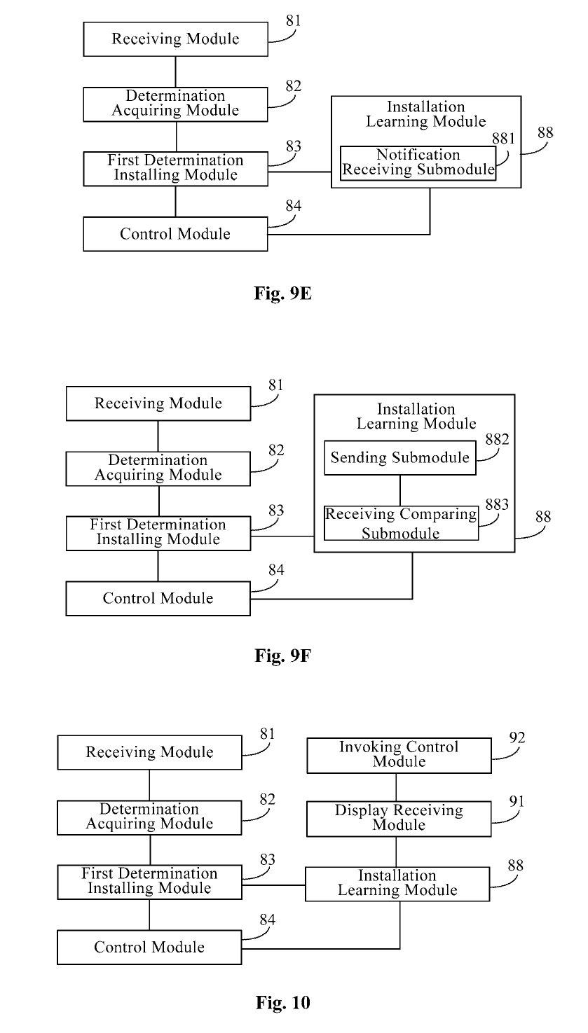

FIG. 9A is a block diagram illustrating another device control apparatus according to an exemplary aspect. As shown in FIG. 9A, on the basis of the aspect as shown in FIG. 8, the apparatus may further include: a second determination installing module 85.

The second determination installing module 85 is configured to overwrite-install the target plug-in acquired by the determination acquiring module 82 in response to determination that a plug-in for controlling all of the additional controllable devices other than the current device to be controlled has been installed.

The apparatus as shown in FIG. 9A is configured to implement the method as shown in FIG. 2, with the same description on related content, and thus is not repeated herein.

In the foregoing aspect of the device control apparatus, the target plug-in is overwrite-installed when the second determination installing module determines that plug-ins for controlling all of the additional controllable devices other than the current device to be controlled have been installed. In other words, a plug-in for a controllable device installed previously will be overwritten by the target plug-in for the current device to be controlled, thereby reducing space occupied by the APP.

FIG. 9B is a block diagram illustrating another device control apparatus according to an exemplary aspect. As shown in FIG. 9B, on the basis of the aspect as shown in FIG. 8, the determination acquiring module 82 may include: a sending submodule 821 and a receiving submodule 822.

The sending submodule 821 is configured to send a plug-in downloading request to the server, where the plug-in downloading request carries therein an identifier of the current device to be controlled, a model number of the current mobile terminal and a version number of a current APP.

The receiving submodule 822 is configured to receive the target plug-in returned by the server according to the plug-in downloading request sent by the sending submodule 821.

The apparatus as shown in FIG. 9B is configured to implement the method as shown in FIG. 3, with the same description on related content, and thus is not repeated herein.

In the foregoing aspect of the device control apparatus, the target plug-in for the current device to be controlled is acquired by sending the plug-in downloading request to the server, and is thus simple for implementation.

FIG. 9C is a block diagram illustrating another device control apparatus according to an exemplary aspect. As shown in FIG. 9C, on the basis of the aspect as shown in FIG. 9B, the apparatus may further include: a sending module 86 and a receiving display module 87.

The sending module 86 is configured to send a controllable device search request to the server before the sending submodule 821 sends the plug-in downloading request to the server.

The receiving display module 87 is configured to receive a controllable device list that is returned by the server and contains an identifier of the current device to be controlled, and display the controllable device list, where the identifier of the current device to be controlled is sent by the current device to be controlled, upon being connected with the current APP, to the server.

The apparatus as shown in FIG. 9C is configured to implement the method as shown in FIG. 3, with the same description on related content, and thus is not repeated herein.

In the foregoing aspect of the device control apparatus, the controllable device list is obtained by sending the controllable device search request to the server, and is thus simple to be implemented.

FIG. 9D is a block diagram illustrating another device control apparatus according to an exemplary aspect. As shown in FIG. 9D, on the basis of the aspect as shown in FIG. 8, the apparatus may further include an installation learning module 88.

The installation learning module 88 is configured to acquire, if it is learned that an update version of the target plug-in is present on the server, the update version of the target plug-in from the server, and install the update version of the target plug-in.

The apparatus as shown in FIG. 9D is configured to implement the method as shown in FIG. 5, with the same description on related content, and thus is not repeated herein.

In the foregoing aspect of the device control apparatus, when it is learned that an update version of the target plug-in is present on the server, the update version of the target plug-in is acquired and installed, and the current device to be controlled is then controlled according to the installed update version of the target plug-in. This partial update manner based on plug-ins may effectively reduce network traffic resources required to be consumed.

FIG. 9E is a block diagram illustrating another device control apparatus according to an exemplary aspect. As shown in FIG. 9E, on the basis of the aspect as shown in FIG. 9D, the installation learning module 88 may include a notification receiving submodule 881.

The notification receiving submodule 881 is configured to receive a notification pushed by the server, where the notification is used to indicate that the update version of the target plug-in is present on the server.

The apparatus as shown in FIG. 9E is configured to implement the method as shown in FIG. 5, with the same description on related content, and thus is not repeated herein.

In the foregoing aspect of the device control apparatus, it is learned that the update version of the target plug-in is present on the server by receiving a notification, a simple way of learning is thus achieved.

FIG. 9F is a block diagram illustrating another device control apparatus according to an exemplary aspect. As shown in FIG. 9F, on the basis of the aspect as shown in FIG. 9D, the installation learning module 88 may include: a sending submodule 882 and a receiving comparing submodule 883.

The sending submodule 882 is configured to send a plug-in version search request to the server, where the plug-in version search request carries an identifier of the current device to be controlled.

The receiving comparing submodule 883 is configured to receive a latest version number corresponding to the current device to be controlled returned by the server according to the plug-in version search request, and learn that the update version of the target plug-in is present on the server when the latest version number is greater than a current version number corresponding to the current device to be controlled.

The apparatus as shown in FIG. 9F is configured to implement the method as shown in FIG. 5, with the same description on related content, and thus is not repeated herein.

In the foregoing aspect of the device control apparatus, it is learned that the update version of the target plug-in is present on the server by sending a plug-in version search request, thus another simple way of learning can be achieved.

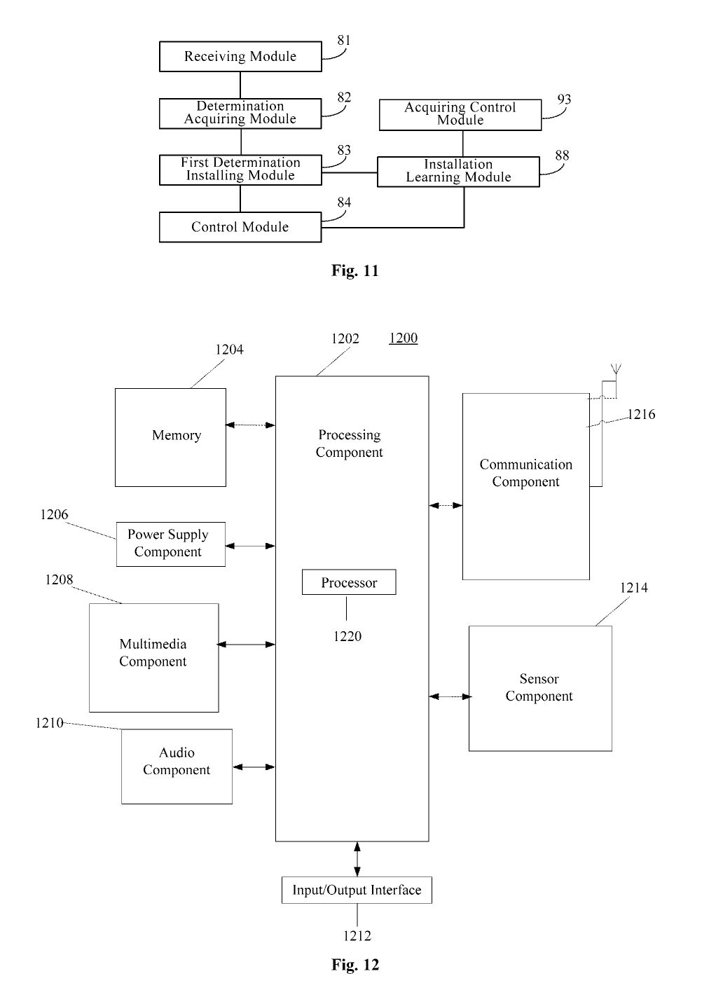

FIG. 10 is a block diagram illustrating a further device control apparatus according to an exemplary aspect. As shown in FIG. 10, on the basis of the aspect as shown in FIG. 9D, the apparatus may further include: a display receiving module 91 and an invoking control module 92.

The display receiving module 91 is configured to display a version number of the target plug-in and that of the update version thereof, and receive a selected version number.

The invoking control module 92 is configured to invoke a corresponding plug-in according to the selected version number received by the display receiving module 91, and control the current device to be controlled according to the invoked plug-in.

In an aspect, both the target plug-in for the current device to be controlled and the update version thereof are saved in the current mobile terminal. The update version of the target plug-in includes therein an identifier and a version number corresponding to the current device to be controlled, or the update version of the target plug-in includes identifiers and version numbers corresponding to the current device to be controlled and other devices to be controlled.

The apparatus as shown in FIG. 10 is configured to implement the method as shown in FIG. 6, with the same description on related content, and thus is not repeated herein.

In the foregoing aspect of the device control apparatus, the selected version number is received, and the corresponding plug-in is invoked according to the selected version number to control the current device to be controlled. Accordingly, a user is enabled to select between a new version and an old version of the plug-in, thereby providing convenience for the user.

FIG. 11 is a block diagram illustrating a still further device control apparatus according to an exemplary aspect. As shown in FIG. 11, on the basis of the aspect as shown in FIG. 9D, the apparatus may further include an acquiring control module 93.

The acquiring control module 93 is configured to acquire a latest version plug-in for the current device to be controlled, and control the current device to be controlled according to the latest version plug-in.

In an aspect, both the target plug-in for the current device to be controlled and the update version thereof are saved in the current mobile terminal. The update version of the target plug-in includes therein an identifier and a version number of the current device to be controlled, or the update version of the target plug-in includes therein identifiers and version numbers of the current device to be controlled as well as other device to be controlled.

The apparatus as shown in FIG. 11 is configured to implement the method as shown in FIG. 6, with the same description on related content, and thus is not repeated herein.

In the foregoing aspect of the device control apparatus, the latest version plug-in is used by default to control the current device to be controlled, so it is easy for implementation.

With regard to the apparatus in the foregoing aspects, detailed description of specific modes for conducting operation of modules and submodules has been made in the aspects related to the method, no detailed illustration will be made herein.

FIG. 12 is a block diagram applicable to a device control apparatus according to an exemplary aspect. For example, the apparatus 1200 may be a mobile telephone, a computer, a digital broadcasting terminal, a message sending and receiving device, a game control center, a tablet device, a medical device, a fitness device, a personal digital assistant, an aircraft and so on.

Referring to FIG. 12, the apparatus 1200 may include one or more components as below: a processing component 1202, a memory 1204, a power supply component 1206, a multimedia component 1208, an audio component 1210, an input′output (I/O) interface 1212, a sensor component 1214 and a communication component 1216.

The processing component 1202 usually controls the overall operation of the apparatus 1200 such as operations relating to display, making call, data communication, taking photos and recording. The processing component 1202 may include one or more processors 1220 to execute instructions to finish all or part steps of the above method. Besides, the processing component 1202 may include one or more modules for facilitating the interaction between the processing component 1202 and other components. For example, the processing component 1202 may include a multimedia module to facilitate the interaction between the multimedia component 1208 and the processing component 1202.

The memory 1204 is configured to store various types of data to support the operation at the apparatus 1200. Examples of the data include any instructions for performing applications or methods at the apparatus 1200, contact data, phone book data, a message, a picture and a video and so on. The memory 1204 may be any types of volatile or non-volatile storage devices or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or compact disk.

The power supply component 1206 provides power for components of the apparatus 1200. The power supply component 1206 may include a power management system, one or more power supplies, and other related components for generating, managing and distributing power for the apparatus 1200.

The multimedia component 1208 includes a screen which provides an output interface between the apparatus 1200 and the user. In some aspects, the screen may include a liquid crystal display (LCD) and a touch panel (TP). If the screen includes a touch panel, the screen may be realized to be a touch screen to receive an input signal from the user. The touch panel includes one or more touch sensors to sense touch, slide and gestures on the touch panel. The touch sensor may not only sense the touch or slide boundary, but also detect the duration time and pressure of the touch or slide operation. In some aspects, the multimedia component 1208 includes a front-facing camera and/or a rear-facing camera. When the apparatus 1200 is in an operation mode, such as a photo mode or video mode, the front-facing camera and/or the rear-facing camera may receive external multimedia data. Each front-facing camera and rear-facing camera may be a fixed optical lens system or have the focal length and optical zoom ability.

The audio component 1210 is configured to output and/or input an audio signal. For example, the audio component 1210 includes a microphone (MIC); when the apparatus 1200 is in an operation mode such as a call mode, a record mode and a speech recognition mode, the microphone is configured to receive an external audio signal. The received audio signal may be further stored in the memory 1204 or sent out by the communication component 1216. In some aspects, the audio component 1210 may further include a loudspeaker for outputting the audio signal.

The I/O interface 1212 may provide interface between the processing component 1202 and a peripheral interface module. The peripheral interface module may be a keyboard, a click wheel, a button and so on. These buttons include but are not limited to: a homepage button, a volume button, a start button and a lock button.

The sensor component 1214 includes one or more sensors for evaluating states of different aspects of the apparatus 1200. For example, the sensor component 1214 may detect the on/off state of the apparatus 1200, relative locations of components, for example, the components are the displayer and keypads of the apparatus 1200. The sensor component 1214 may further sense the position change of a component of the apparatus 1200 or the position change of the apparatus 1200, whether the touch exists between the user and the apparatus 1200, the direction or acceleration/deceleration of the apparatus 1200, and temperature change of the apparatus 1200. The sensor component 1214 may include a proximity sensor which is configured to sense the existence of a nearby object when no physical contact exists. The sensor component 1214 may further include a light sensor such as a CMOS or CCD image sensor, for using in imaging applications. In some aspects, the sensor component 1214 may further include an acceleration sensor, a gyro sensor, a magnetic sensor, a pressure sensor, or a temperature sensor.

The communication component 1216 is configured to facilitate communicating between the apparatus 1200 and other devices in wired or wireless manner. The apparatus 1200 may be connected to wireless network based on communication standard such as wireless fidelity (Wi-Fi), 2G or 3G or their combinations. In an exemplary aspect, the communication component 1216 receives, by means of a broadcast channel, a broadcast signal or broadcast-related information from an external broadcast management system. In an exemplary aspect, the communication component 1216 further includes a near field communication (NFC) module to promote short-range communication. For example, the NFC module may be achieved based on radio frequency identification (RFID) technology, infrared data association (IrDA) technology, ultra-wide bandwidth (UWB) technology, Bluetooth (BT) technology and other technologies.

In exemplary aspects, the apparatus 1200 may be achieved by one or more of application specific integrated circuit (ASIC), digital signal processor (DSP), digital signal processing device (DSPD), programmable logic device (PLD), field programmable gate array (FPGA), controller, microcontroller, microprocessor or other electronic components for executing the method above.

In exemplary aspects, a non-transitory computer-readable storage medium including an instruction is also provided, for example, the memory 1204 including the instruction. The instruction may be executed by the processor 1220 of the apparatus 1200 to achieve the above method. For example, the non-transitory computer-readable storage medium may be a ROM, a random access memory (RAM), a CD-ROM, a magnetic tape, a floppy disk and optical data storage device, etc.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for controlling a device, the method comprising:
receiving a control instruction associated with a first device;
determining that a first program plugin is not installed, wherein the first program plugin is configured to control the first device;
acquiring the first program plugin from a server, the first program plugin including a control interface and a control logic;
determining that a second program plugin is installed, wherein the second program plugin is configured to control a first set of devices that are different from the first device;
installing the first program plugin based on the determination that the second program plugin is installed; and
controlling the first device based on the control instruction and the first program plugin.

2. The method of claim 1, wherein installing the first program plugin includes overwriting the second program plugin with the first program plugin.

3. The method of claim 1, wherein the first set of devices includes smart devices located within a same local area network (LAN).

4. The method of claim 1, wherein acquiring the first program plugin includes:
sending to the server a first request to acquire the first program plugin, wherein the first request includes an identifier of the first device, a model number of a first mobile terminal; and a version number of a first application; and
receiving from the server the first program plugin based on the first request.

5. The method of claim 4, wherein before sending the first request, the method further comprises:
sending to the server a second request to acquire a list of controllable devices;
receiving from the server the list of controllable devices including the identifier of the first device; and
displaying the list of controllable devices, wherein the identifier of the first device is sent to the server by the first device after the first device establishes a connection with the first application.

6. The method of claim 1, further comprising:
determining that an updated version of the first program plugin exists on the server;
acquiring the updated version of the first program plugin from the server; and
installing the updated version of the first program plugin.

7. The method of claim 6, wherein determining that the updated version of the first program plugin exists on the server includes:
receiving from the server a push notification indicating that the updated version of the first program plugin exists on the server.

8. The method of claim 6, wherein determining that the updated version of the first program plugin exists on the server includes:
sending to the server a program plugin version search request including an identifier of the first device;
receiving from the server a latest version number of the first program plugin corresponding to the first device; and
determining that the updated version of the first program plugin exists on the server when the latest version number is greater than a current version number of the first program plugin.

9. The method of claim 6, wherein the first program plugin and the updated version of the first program plugin are stored in a first mobile terminal; and
wherein the updated version of the first program plugin includes (i) an identifier and a version number of the first device, or (ii) identifiers and version numbers of the first device and other devices to be controlled.

10. An apparatus for controlling a device, the apparatus comprising:
a processor; and
a memory configured to store instructions executable by the processor, wherein the processor is configured to:
receive a control instruction associated with a first device;
acquire the first program plugin from a server, the first program plugin including a control interface and a control logic;
determine that a second program plugin is installed, wherein the second program plugin is configured to control a first set of devices that are different from the first device;
install the first program plugin based on the determination that the second program plugin is installed; and
control the first device based on the control instruction and the first program plugin.

11. The apparatus of claim 10, the processor is further configured to install the first program plugin by overwriting the second program plugin with the first program plugin.

12. The apparatus of claim 10, wherein the first set of devices includes smart devices located within a same local area network (LAN).

13. The apparatus of claim 10, wherein when acquiring the first program plugin, the processor is configured to:
send to the server a first request to acquire the first program plugin, wherein the first request includes an identifier of the first device, a model number of a first mobile terminal, and a version number of a first application; and
receive from the server the first program plugin based on the first request.

14. The apparatus of claim 13, wherein before sending the first request, the processor is further configured to:
send to the server a second request to acquire a list of controllable devices;
receive from the server the list of controllable devices including the identifier of the first device; and
display the list of controllable devices, wherein the identifier of the first device is sent to the server by the first device after the first device establishes a connection with the first application.

15. The apparatus of claim 10, wherein the processor is further configured to:
determine that an updated version of the first program plugin exists on the server;
acquire the updated version of the first program plugin from the server; and
install the updated version of the first program plugin.

16. The apparatus of claim 15, wherein when determining that the updated version of the first program plugin exists on the server, the processor is configured to:
receive from the server a push notification indicating that the updated version of the first program plugin exists on the server.

17. The apparatus of claim 15, wherein when determining that the updated version of the first program plugin exists on the server, the processor is configured to:
send to the server a program plugin version search request including an identifier of the first device;
receive from the server a latest version number of the first program plugin corresponding to the first current device; and
determine that the updated version of the first program plugin exists on the server when the latest version number is greater than a current version number of the first program plugin.

18. The apparatus of claim 15, wherein the first program plugin and the updated version of the first program plugin are stored in a first mobile terminal; and
wherein the updated version of the first program plugin includes (0 an identifier and a version number of the first device, or (ii) identifiers and version numbers of the first device and other devices to be controlled.

19. A non-transitory computer-readable storage medium having stored therein instructions that, when executed by a processor, cause the processor to perform a method, the method comprising:
receiving a control instruction associated with a first device;
determining that a first program plugin is not installed, wherein the first program plugin is configured to control the first device;
acquiring the first program plugin from a server, the first program plugin including a control interface and a control logic;
determining that a second program plugin is installed, wherein the second program plugin is configured to control a first set of devices that are different from the first device;
installing the first program plugin based on the determination that the second program plugin is installed; and
controlling the first device based on the control instruction and the first program plugin.
